(19) United States
(12) Patent Application Publication
(10) Pub. No.: US 2023/0371537 A1
(43) Pub. Date: Nov. 23, 2023

(54) LIQUID FERMENTED MILK

(71) Applicant: MEIJI CO., LTD., Tokyo (JP)

(72) Inventors: Yoshitaka KAWAI, Tokyo (JP); Momoka ISETANI, Tokyo (JP); Megumi TAKAI, Tokyo (JP)

(73) Assignee: MEIJI CO., LTD., Tokyo (JP)

(21) Appl. No.: 18/030,559

(22) PCT Filed: Oct. 6, 2021
(86) PCT No.: PCT/JP2021/036979

§ 371 Date: Apr. 6, 2023

Related U.S. Application Data
(60) Provisional application No. 63/088,540, filed on Oct. 7, 2020.

(51) Int. Cl. A23C 9/123

(52) U.S. Cl. CPC A23C 9/1238; A23V 2400/137; A23V 2400/123; A23V 2400/249

(57) ABSTRACT

Provided is a liquid fermented milk that, while keeping a sourness that is favorable for yogurt, particularly a sourness in a latter stage, has a satisfactory drink feeling and a rich taste, and has a strong feeling of remaining in the mouth, and a long-lasting afterglow of a yogurt flavor. The liquid fermented milk has, in a dynamic property measurement using a measurement device in which a sample of a liquid fermented milk is supplied from a supply unit disposed on an inclined surface onto the inclined surface, the sample supplied from the supply unit toward the inclined surface is detected with a supply sensor, the sample flowing down or sliding down through a predetermined point on the inclined surface is detected with an arrival sensor, the timing of a detection of the sample with each of the supply sensor and the arrival sensor is recorded with a timing recording unit, an image of the sample flowing down or sliding down on the inclined surface is taken from above the inclined surface to obtain a front image, an image of the sample flowing down or sliding down on the inclined surface is taken from a side of the inclined surface to obtain a lateral image, and a state parameter that represents a state of the sample flowing down or sliding down on the inclined surface is calculated using at least one of an output of the timing recording unit, the front image, and the lateral image, whereby a state of swallowing of the sample is simulatively reproduced and a movement and a shape of the sample are measured, an upper part velocity of the sample flowing down or sliding down on the inclined surface of 0.2 m/s or more and 0.55 m/s or less, a maximum thickness of the sample flowing down or sliding down on the inclined surface of 1.4 mm or more and 4 mm or less, a final thickness of the sample flowing down or sliding down on the inclined surface of 0.20 mm or more and 0.7 mm or less, and a shear stress of the sample flowing down or sliding down on the inclined surface of 0.0075 N/m² or more and 0.04 N/m² or less.

### TECHNICAL FIELD

The present invention relates to a liquid fermented milk.

### BACKGROUND ART

It has been required to suppress global expansion of a variety of infectious diseases in recent years. However, in spite of the increased drug-resistant bacteria in the world, development of new antimicrobial agent is declining.

On the other hand, many lactic acid bacteria and exopolysaccharides having an immunostimulative action have been found, and have been applied in liquid fermented milk (drinking yogurt) or many other foods and drinks.

A highly satisfactory palatability and texture upon eating are required for a liquid fermented milk, and in addition, a new palatability and texture upon eating are also required.

PTL 1 discloses a method for producing a liquid fermented milk that achieves both of dense smooth consistency leading to good throat flow and rich body without using any stabilizer or thickener, the liquid fermented milk containing milk protein in an amount of 2.5% or more, the milk protein containing whey protein in an amount of 25% or more, the liquid fermented milk having a viscosity at 10° C. of 100 mPa·s or more and 700 mPa·s or less.

The liquid fermented milk disclosed in PTL 1 is a liquid fermented milk that has good throat flow, and flows fast in the mouth or in the throat, and has a small degree of afterglow of taste.

PTL 2 discloses a measurement device and a method for estimating the behavior of bolus and the texture upon eating in eating or swallowing, and describes results of evaluation of a food with an adjusted thickness.

PTL 3 discloses a method for producing a fermented milk using L. bulgaricus OLL1073R-1 and S. thermophilus OLS3059 as starter bacteria, the method being able to increase the amount of EPS produced.

### CITATION LIST

### Patent Literature

PTL 1: JP-A-2020-022406

PTL 2: WO2017/026090

PTL 3: JP-A-2005-194259

### SUMMARY OF INVENTION

### Technical Problem

PTL 1 does not describe a liquid fermented milk that has a satisfactory drink feeling and a remaining afterglow of taste.

PTL 2 has no statement about evaluation of the liquid fermented milk.

PTL 3 has no statement about palatability, such as texture upon eating.

The present invention has an object to provide a liquid fermented milk that, while keeping a sourness that is favorable for yogurt, particularly a sourness in a latter stage, has a satisfactory drink feeling and a rich taste, and has a strong feeling of remaining in the mouth, and a long-lasting afterglow of a yogurt flavor in order to address diversification in palatability of customers and in method of eating yogurt by customers.

### Solution to Problem

The present inventors have found that, by designing a liquid fermented milk so as to have, in the dynamic property measurement using a measurement device as described in PTL 2 in which a state of swallowing of a sample is simulatively reproduced and a movement and a shape of the sample are measured, an upper part velocity, a maximum thickness, a final thickness, and a shear stress that are each a predetermined value, it is possible to provide a liquid fermented milk that, while keeping a sourness that is favorable for yogurt, particularly a sourness in a latter stage, has a satisfactory drink feeling and a rich taste, and has a strong feeling of remaining in the mouth, and a long-lasting afterglow of a yogurt flavor.

The liquid fermented milk of the present invention is configured as follows. In a dynamic property measurement using a measurement device in which a sample of a liquid fermented milk is supplied from a supply unit disposed on an inclined surface onto the inclined surface, the sample supplied from the supply unit toward the inclined surface is detected with a supply sensor, the sample flowing down or sliding down through a predetermined point on the inclined surface is detected with an arrival sensor, the timing of a detection of the sample with each of the supply sensor and the arrival sensor is recorded with a timing recording unit, an image of the sample flowing down or sliding down on the inclined surface is taken from above the inclined surface to obtain a front image, an image of the sample flowing down or sliding down on the inclined surface is taken from a side of the inclined surface to obtain a lateral image, and a state parameter that represents a state of the sample flowing down or sliding down on the inclined surface is calculated using at least one of an output of the timing recording unit, the front image, and the lateral image, whereby a state of swallowing of the sample is simulatively reproduced and a movement and a shape of the sample are measured, the liquid fermented milk has an upper part velocity of the sample flowing down or sliding down on the inclined surface of 0.2 m/s or more and 0.55 m/s or less, a maximum thickness of the sample flowing down or sliding down on the inclined surface of 1.4 mm or more and 4 mm or less, a final thickness of the sample flowing down or sliding down on the inclined surface of 0.20 mm or more and 0.7 mm or less, and a shear stress of the sample flowing down or sliding down on the inclined surface of 0.0075 N/m² or more and 0.04 N/m² or less.

### Advantageous Effects of Invention

According to the present invention, it is possible to provide a liquid fermented milk that, while keeping a sourness that is favorable for yogurt, particularly a sourness in a latter stage, has a satisfactory drink feeling and a rich taste, and has a strong feeling of remaining in the mouth, and a long-lasting afterglow of a yogurt flavor.

### BRIEF DESCRIPTION OF DRAWINGS

FIG. 1 is a graph showing shear rate dependence in viscosity of each sample according to examples.

FIG. 2 is an explanatory drawing showing scores of sensory evaluations of each sample according to examples.

### DESCRIPTION OF EMBODIMENTS

An embodiment of the present invention will be described below. However, the embodiment described below is merely an example, and can be appropriately modified within the scope that is obvious to a person skilled in the art.

### Embodiment

### (Characteristics of Liquid Fermented Milk (Drinking Yogurt))

A liquid fermented milk of this embodiment has an upper part velocity, a maximum thickness, a final thickness, and a shear stress that are each a predetermined value in a dynamic property measurement in which a state of swallowing of a sample is simulatively reproduced and a movement and a shape of the sample are measured using a predetermined measurement device (described later) including an inclined surface.

The measurement device for measuring dynamic properties of the liquid fermented milk of this embodiment will be described. The measurement device includes an inclined surface. The inclined surface is a surface inclined at an angle of, for example, 60° C. relative to an horizontal surface. The inclined surface includes a supply unit, and is configured so that a sample of the liquid fermented milk can be suppled from the supply unit onto the inclined surface.

The inclined surface is a surface on which the sample flows down or slides down, and is formed of, for example, a hydrophilic resin sheet (hereinafter also referred to as “resin film” or simply as “film”) of hydrophilic polyvinyl alcohol (PVA) or the like. The resin film is, for example, a film having a thickness of 2 to 3 mm.

The measurement device has a supply sensor and an arrival sensor. The supply sensor detects the sample supplied from the supply unit toward the inclined surface. The arrival sensor detects the sample flowing down or sliding down through a predetermined point on the inclined surface.

The measurement device has a timing recording unit. The timing recording unit records the timing of the detection of the sample with each of the supply sensor and the arrival sensor.

The measurement device includes a camera disposed above so as to take an image of the sample flowing down or sliding down on the inclined surface from above the inclined surface to obtain a front image, a camera disposed on a side so as to take an image from the side to obtain a lateral image, and the like.

The measurement device further includes a calculation unit that calculates a state parameter that represents a state of the sample flowing down or sliding down on the inclined surface using at least one of an output of the timing recording unit, the front image, and the lateral image.

A method for measuring dynamic properties of the liquid fermented milk of this embodiment will be described. In the measurement device of the above configuration, when a sample of the liquid fermented milk is supplied onto the inclined surface from the supply unit disposed on the inclined surface, the sample flows down or slides down on the inclined surface. The sample supplied from the supply unit toward the inclined surface is detected with the supply sensor, and the sample flowing down or sliding down through the predetermined point on the inclined surface is detected with the arrival sensor. The timing of the detection of the sample with each of the supply sensor and the arrival sensor is recorded with the timing recording unit. An image of the sample flowing down or sliding down on the inclined surface is taken from above the inclined surface to obtain a front image, and an image of the sample flowing down or sliding down on the inclined surface is taken from a side of the inclined surface to obtain a lateral image. A state parameter that represents a state of the sample flowing down or sliding down on the inclined surface is calculated using at least one of an output of the timing recording unit, the front image, and the lateral image, whereby a state of swallowing of the sample is simulatively reproduced and a movement and a shape of the sample are measured.

As the above configuration and other configurations of the measurement device, the configuration described in PTL 2 can be applied. The measurement device described in PTL 2 can measure, using various sensors and high-speed cameras, various dynamic properties, such as “degree of spreading”, “speed of flowing”, and “thickness”, of a flowable food that is allowed to flow on a hydrophilic resin sheet (film) which is a simulated mucous membrane.

In the above measurement device, the inclined surface is divided, in the order from the side of the upper end, into an upper part, a middle part, and a lower part. For example, when the length of from the upper end to the lower end of the inclined surface is 10.5 cm or more, a part from a position of 3.5 cm from the upper end to a position of 5.0 cm from the upper end is taken as the upper part. Apart of from a position of 5.0 cm from the upper end to a position of 9.0 cm from the upper end is taken as the middle part. A prat of from a position of 9.0 cm from the upper end to a position of 10.5 cm from the upper end is taken as the lower part.

When a sample of the liquid fermented milk is supplied on the inclined surface, the sample flows down or slides down on the inclined surface. Based on the timing of supply, the timing of the detection, the front image, and the lateral image obtained in this time, a state parameter that represents a state of the sample is calculated and measured. For example, the speed of the sample flowing down or sliding down on the upper part is measured as an upper part velocity, and the speed of the sample flowing down or sliding down on the lower part is measured as a lower part velocity. The time taken for the sample to flow down or slide down on the upper part to transit the upper part is measured as an upper part transit time, and the time taken for the sample to flow down or slide down on the lower part to transit the lower part is measured as a lower part transit time.

In the above measurements, the thickness of the sample at 7 cm from the upper end of the inclined surface at the time when the tip end of the sample reaches 10.5 cm from the upper end of the inclined surface is detected with a reflective sensor and is measured as a δ thickness. The thickness detected at 1000 ms after the supply timing is measured as a final thickness. The thickness at the time when the sample thickness becomes the maximum is measured as a maximum thickness. The value of [(δ thickness)×(gravitational acceleration (g)×sin 60°−(lower part velocity−upper part velocity)/(lower part transit time−upper part transit time)))] is measured as a shear stress.

In the liquid fermented milk of this embodiment, the upper part velocity of the sample flowing down or sliding down on the inclined surface is 0.2 m/s or more and 0.55 m/s or less. The maximum thickness is 1.4 mm or more and 4 mm or less. The final thickness is 0.20 mm or more and 0.7 mm or less. The shear stress is 0.0075 N/m² or more and 0.04 N/m² or less.

The upper part velocity is preferably 0.2 m/s or more and 0.50 m/s or less, and further preferably 0.3 m/s or more and 0.45 m/s or less. The maximum thickness is preferably 1.7 mm or more and 4 mm or less, and further preferably 1.8 mm or more and 3 mm or less. The final thickness is preferably 0.25 mm or more and 0.7 mm or less, and further preferably 0.29 mm or more and 0.6 mm or less. The shear stress is preferably 0.0080 N/m² or more and 0.03 N/m² or less, and further preferably 0.0080 N/m² or more and 0.02 N/m² or less.

A preferred combination of the state parameters is an upper part velocity of 0.2 m/s or more and 0.50 m/s or less, a maximum thickness of 1.7 mm or more and 4 mm or less, a final thickness of 0.25 mm or more and 0.7 mm or less, and a shear stress of 0.0080 N/m² or more and 0.03 N/m² or less.

A further preferred combination is an upper part velocity of 0.3 m/s or more and 0.45 m/s or less, a maximum thickness of 1.8 mm or more and 3 mm or less, a final thickness of 0.29 mm or more and 0.6 mm or less, and a shear stress of 0.0080 N/m² or more and 0.02 N/m² or less.

The liquid fermented milk of this embodiment preferably has a content of whey protein isolate (WPI) of 0.6% or more. The WPI content is further preferably more than 0.6%. The WPI content is furthermore preferably 0.7% or more. The WPI content is most preferably 1% or more.

The liquid fermented milk of this embodiment preferably does not contain at least one of a thickener and a stabilizer. The liquid fermented milk further preferably does not contain any of a thickener and a stabilizer.

### (Production Method of Liquid Fermented Milk)

For producing the liquid fermented milk of this embodiment, for example, predetermined amounts of skim milk powder, WPI, sugar, stevia, raw material water, and the like are mixed with milk to prepare a fermented milk base, the obtained fermented milk base is sterilized, and then, a lactic acid bacteria starter is added thereto to cause fermentation. Then, curd of the obtained fermented milk is homogenized with a homogenizer, and is thickened by keeping the homogenized curd at a predetermined temperature for a predetermined period of time, whereby the liquid fermented milk can be produced.

The liquid fermented milk of this embodiment is preferably produced without addition of at least one of a thickener and a stabilizer. The liquid fermented milk is further preferably produced without addition of any of a thickener and a stabilizer.

The liquid fermented milk of this embodiment is preferably obtained by fermentation with at least one of Lactobacillus lactic acid bacteria and Streptococcus lactic acid bacteria. The Lactobacillus lactic acid bacteria are preferably lactic acid bacteria belonging to Lactobacillus delbrueckii, more preferably lactic acid bacteria belonging to Lactobacillus delbrueckii subsp. bulgaricus, and particularly preferably Lactobacillus delbrueckii subsp. bulgaricus OLL1073R-1 strain (L. bulgaricus OLL1073R-1 (deposit number: FERM BP-10741)). Streptococcus lactic acid bacteria are preferably lactic acid bacteria belonging to Streptococcus thermophilus, and more preferably Streptococcus thermophilus OLS3059 strain (S. thermophilus OLS3059 (deposit number: FERM BP-10740)). The liquid fermented milk of this embodiment may contain lactic acid bacteria other than Lactobacillus and Streptococcus, or Bifidobacterium.

### (Action and Effect of Liquid Fermented Milk)

According to the aforementioned liquid fermented milk of this embodiment, it is possible to attain a liquid fermented milk that, while keeping a sourness that is favorable for yogurt, particularly a sourness in a latter stage, has a satisfactory drink feeling and a rich taste, and has a strong feeling of remaining in the mouth, and a long-lasting afterglow of a yogurt flavor.

In the dynamic property measurement using the aforementioned measurement device, by designing a liquid fermented milk so that the upper part velocity, the maximum thickness, the final thickness, and the shear stress are each a predetermined value, a liquid fermented milk that has a satisfactory drink feeling and a rich taste, and has a strong feeling of remaining in the mouth, and a long-lasting afterglow of a yogurt flavor can be provided without repeated trial productions and sensory evaluations.

### EXAMPLES

A sample of a liquid fermented milk (drinking yogurt) was produced as follows.

### Production of Example 1

In Example 1, 6120 g of milk, 141 g of skim milk powder, 163 g of WPI, 540 g of sugar, 0.45 g of stevia, and 1956 g of raw material water were mixed to prepare a fermented milk base (SNF 8.2%, FAT 2.6%). The WPI content was 0.7%.

Subsequently, the prepared fermented milk base was sterilized at a reached temperature of 95° C., and then, 180 g of a lactic acid bacteria starter obtained by culturing L. bulgaricus OLL1073R-1 (deposit number: FERM BP-10741) and S. thermophilus OLS3059 (deposit number: FERM BP-10740) in a 10% skim milk powder medium was added thereto, and fermentation was performed at 43° C. for 3 to 5 hours until the pH became 4.3.

The obtained fermented milk curd was broken with a homogenizer (manufactured by IZUMI FOOD MACHINERY Co., Ltd.) at a flow rate of 135 L/h and a pressure of 15 MPa. Then, the broken fermented milk was filled in a container and was kept at 10° C. for 10 days to be thickened, thus producing a liquid fermented milk of Example 1.

### Production of Example 2

In Example 2, a liquid fermented milk was prepared in the same manner as in Example 1 except for changing the WPI content in Example 1 to 1.0%.

### Production of Comparative Example 1

In Comparative Example 1, a liquid fermented milk was prepared in the same manner as in Example 1 except for changing the WPI ratio in Example 1 to 0.3%.

### (Measurement of Physical Properties of Each Sample)

Each of the liquid fermented milk samples prepared in Example 1 (WPI content: 0.7%), Example 2 (WPI content: 1.0%), and Comparative Example 1 (WPI content: 0.3%) was subjected to a dynamic property measurement in which a movement and a shape of the sample were measured with the measurement device described in PTL 2.

### (Measurement Device and Measurement Method)

Using the measurement device described in PTL 2, each sample was placed under a condition of room temperature at an inclination degree of 60° relative to a horizontal surface. A resin sheet of PVA (manufactured by JMC, thickness: 3 mm) was used as the resin sheet (film) constituting the inclined surface. Before the sample was supplied, tap water was allowed to flow over the entire film and then, the film was naturally dried for 30 seconds. In one measurement, 4 mL of a sample was supplied from a pump unit, to obtain various measurement values while the sample flowed down or slid down on the film at a supply speed of 100 mm/s. A part of 3.5 cm to 5 cm from the film upper end at which a sample supply port was provided was taken as an upper part, a part of 5 cm to 9 cm from the film upper end was as a middle part, and a part of 9 cm to 10.5 cm from the film upper end was as a lower part.

The velocities on the upper part, the middle part, and the lower part (the upper part velocity, the middle part velocity, and the lower part velocity, respectively), and the transit times therethrough were calculated. The thickness of the sample at a point of 7 cm from the film upper end at the time when the tip end of the liquid reached 10.5 cm from the film upper end was taken as a 5 thickness. The thickness of the sample detected at 1000 ms after the sample supply timing was taken as a final thickness (H). The thickness at the time when the thickness of the sample became maximum was taken as a maximum thickness (T). From the time when the maximum thickness was detected (Tt), the final thickness (T), and the final thickness (H), (H−T)/(1000−Tt) was calculated and was taken as a thickness attenuation slope. An area of the sample on the middle part (S) was calculated at the time when the tip end of the sample reached 10.5 cm from the film upper end. A shear stress (i) was calculated from [(δ thickness)×(gravitational acceleration (g)×sin 60°−(lower part velocity−upper part velocity)/(lower part transit time−upper part transit time))]. The measurement was performed seven times and the average was determined. Comparisons among levels (Examples 1, 2, and Comparative Example 1 having different WPI contents) were performed by Tukey-Kramer's HSD test.

The measurement results are shown in Tables 1 and 2. Table 1 shows results of measurements of the samples with the aforementioned measurement device. Table 2 shows comparisons of the measurement results between levels (the numerical values in the table represent p values of the Tukey-Kramer's HSD test).

TABLE 1

| | | | | | | | | Upper | Lower | |
|---|---|---|---|---|---|---|---|---|---|---|
| | Upper | Middle | Lower | | | | | part | part | |
| | part | part | part | δ | Final | Maximum | Thickness | transit | transit | Shear |
| | velocity | velocity | velocity | Thickness | thickness | thickness | attenuation | time | time | stress |
| Sample | m/s | m/s | m/s | mm | mm | mm | slope | msec | msec | N/m2 |
| Example 1 | 0.417 | 0.526 | 0.457 | 1.407 | 0.290 | 1.908 | −0.0023 | 34.8 | 36.3 | 0.012 |
| Example 2 | 0.378 | 0.349 | 0.342 | 2.546 | 0.573 | 2.720 | −0.0031 | 38.5 | 48.2 | 0.022 |
| Comparative | 0.572 | 0.616 | 0.411 | 0.852 | 0.126 | 1.374 | −0.0016 | 25.4 | 40.2 | 0.007 |
| Example 1 | | | | | | | | | | |

TABLE 2

| | | | | | | | | | Upper | Lower | |
|---|---|---|---|---|---|---|---|---|---|---|---|
| | | Upper | Middle | Lower | | | | Thickness | part | part | |
| | | part | part | part | δ | Final | Maximum | attenuation | transit | transit | Shear |
| Level 1 | Level 2 | velocity | velocity | velocity | Thickness | thickness | thickness | slope | time | time | stress |
| Comparative | Example 1 | <.0001 | <.0001 | <.0001 | <.0001 | 0.0004 | <.0001 | 0.0008 | <.0001 | <.0001 | 0.0012 |
| Example 1 | | | | | | | | | | | |
| Comparative | Example 2 | <.0001 | <.0001 | <.0001 | <.0001 | <.0001 | <.0001 | <.0001 | <.0001 | <.0001 | <.0001 |
| Example 1 | | | | | | | | | | | |
| Example 1 | Example 2 | 0.0224 | <.0001 | 0.0036 | 0.001 | 0.0309 | 0.0022 | 0.0055 | 0.002 | 0.0065 | <.0001 |

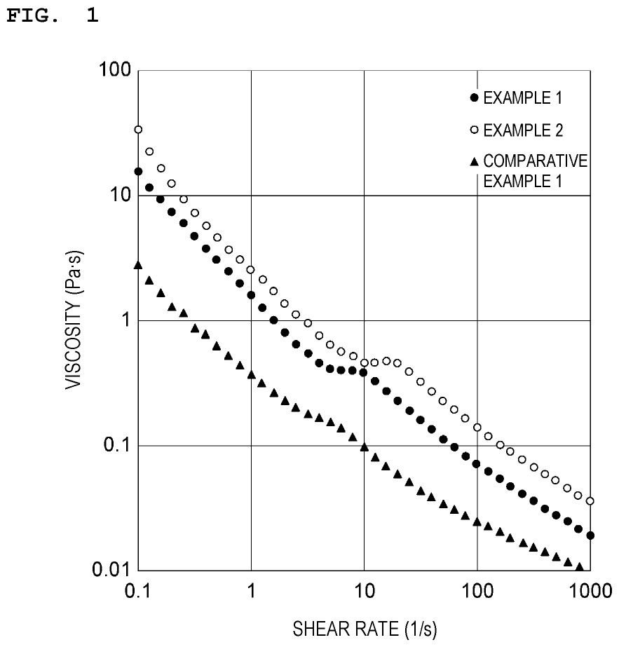

The shear rate dependence in viscosity of each sample obtained from the measurement results of the sample will be described. Table 3 shows the viscosity of each sample at each shear rate. FIG. 1 is a graph showing the shear rate dependence in viscosity of each sample.

TABLE 3

| | | | | Comparative |
|---|---|---|---|---|
| Measurement | Shear rate | Example 1 | Example 2 | Example 1 |
| point number | [1/s] | [Pa · s] | [Pa · s] | [Pa · s] |
| 1 | 0.1 | 15.46 | 33.66 | 2.754 |
| 2 | 0.1259 | 11.59 | 22.59 | 2.07 |
| 3 | 0.1585 | 9.275 | 16.38 | 1.668 |
| 4 | 0.1995 | 7.416 | 12.31 | 1.284 |
| 5 | 0.2512 | 5.993 | 9.385 | 1.137 |
| 6 | 0.3162 | 4.74 | 7.277 | 0.8651 |
| 7 | 0.3981 | 3.77 | 5.738 | 0.7757 |
| 8 | 0.5012 | 3.041 | 4.591 | 0.6331 |
| 9 | 0.6309 | 2.453 | 3.721 | 0.5229 |
| 10 | 0.7943 | 1.978 | 3.067 | 0.4336 |
| 11 | 1 | 1.58 | 2.533 | 0.3672 |
| 12 | 1.259 | 1.258 | 2.095 | 0.315 |
| 13 | 1.585 | 1.003 | 1.715 | 0.2641 |
| 14 | 1.995 | 0.7992 | 1.372 | 0.2286 |
| 15 | 2.512 | 0.6497 | 1.11 | 0.201 |
| 16 | 3.162 | 0.5413 | 0.9524 | 0.1799 |
| 17 | 3.981 | 0.4611 | 0.7698 | 0.1696 |
| 18 | 5.012 | 0.4162 | 0.6383 | 0.1564 |
| 19 | 6.309 | 0.403 | 0.5622 | 0.138 |
| 20 | 7.943 | 0.4028 | 0.5133 | 0.1169 |
| 21 | 10 | 0.3787 | 0.4601 | 0.09618 |
| 22 | 12.59 | 0.3247 | 0.4589 | 0.08087 |
| 23 | 15.85 | 0.2713 | 0.4713 | 0.06905 |
| 24 | 19.95 | 0.2271 | 0.4586 | 0.05889 |
| 25 | 25.12 | 0.1896 | 0.3958 | 0.05117 |
| 26 | 31.62 | 0.1593 | 0.3306 | 0.04429 |
| 27 | 39.81 | 0.1342 | 0.2764 | 0.03897 |
| 28 | 50.12 | 0.1137 | 0.2313 | 0.03449 |
| 29 | 63.1 | 0.09678 | 0.1944 | 0.03077 |
| 30 | 79.43 | 0.08273 | 0.1644 | 0.0276 |
| 31 | 100 | 0.07108 | 0.1396 | 0.02488 |
| 32 | 125.9 | 0.06152 | 0.1193 | 0.02251 |
| 33 | 158.5 | 0.05354 | 0.1026 | 0.02036 |
| 34 | 199.5 | 0.04677 | 0.08861 | 0.01852 |
| 35 | 251.2 | 0.04102 | 0.07696 | 0.01688 |
| 36 | 316.2 | 0.03604 | 0.06715 | 0.01547 |
| 37 | 398.1 | 0.03177 | 0.05893 | 0.01414 |
| 38 | 501.2 | 0.028 | 0.05187 | 0.01296 |
| 39 | 631 | 0.02478 | 0.04583 | 0.01185 |
| 40 | 794.3 | 0.02187 | 0.04049 | 0.01086 |
| 41 | 1000 | 0.01935 | 0.03577 | 0.009927 |

As shown in FIG. 1, the viscosity at the time when each shear rate of each sample was obtained was in the order of Example 2>Example 1>Comparative Example 1.

### (Sensory Evaluation)

The liquid fermented milk of Example 1 (WPI content: 0.7%), Example 2 (WPI content: 1.0%), and Comparative Example 1 (WPI content: 0.3%) were subjected to sensory evaluations by 32 trained panelists. “Sourness”, “sourness in latter stage”, “preference of sourness”, “degrees of rich taste”, “throat flow”, “degree of satisfactory drink feeling”, “clear feeling of aftertaste”, and “feeling of remaining in the mouth” were evaluated by a scoring method according to an absolute evaluation method (seven-grade scale) and the averages thereof were calculated. Table 4 shows criteria of the sensory evaluations.

TABLE 4

| | Score | | | | | | |
|---|---|---|---|---|---|---|---|
| Evaluation term | −3 | −2 | −1 | 0 | 1 | 2 | 3 |
| Sourness | Very | Weak | Slightly | Moderate | Slightly | Strong | Very |
| | weak | | weak | | strong | | strong |
| Sourness in latter | Very | Weak | Slightly | Moderate | Slightly | Strong | Very |
| stage | weak | | weak | | strong | | strong |
| Preference of sourness | Very | Disliked | Slightly | Moderate | Slightly | Favorite | Very |
| | disliked | | disliked | | favorite | | favorite |
| Degree of rich taste | Very | Weak | Slightly | Moderate | Slightly | Strong | Very |
| | weak | | weak | | strong | | strong |
| Degree of throat flow | Very | Weak | Slightly | Moderate | Slightly | Strong | Very |
| | weak | | weak | | strong | | strong |
| Degree of satisfactory | Very | Weak | Slightly | Moderate | Slightly | Strong | Very |
| drink feeling | weak | | weak | | strong | | strong |
| Clear feeling of | Very | Weak | Slightly | Moderate | Slightly | Strong | Very |
| aftertaste | weak | | weak | | strong | | strong |
| Feeling of remaining in | Very | Weak | Slightly | Moderate | Slightly | Strong | Very |
| the mouth | weak | | weak | | strong | | strong |

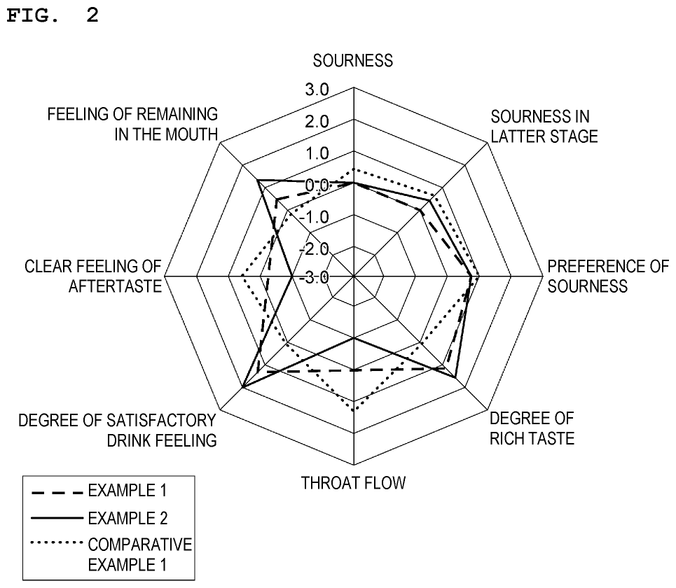

Table 5 shows the sensory evaluation scores of each sample. FIG. 2 is an explanatory drawing showing scores of the sensory evaluations of each sample.

TABLE 5

| | | | | | | Degree of | | Feeling of |
|---|---|---|---|---|---|---|---|---|
| | | Sourness | | Degree | | satisfactory | Clear | remaining |
| | | in latter | Preference | of rich | Throat | drink | feeling of | in the |
| Sample | Sourness | stage | of sourness | taste | flow | feeling | aftertaste | mouth |
| Example 1 | 0.1 | 0.0 | 0.7 | 1.2 | 0.0 | 1.4 | −0.2 | 0.5 |
| Example 2 | 0.0 | 0.4 | 0.7 | 1.6 | −1.1 | 2.1 | −0.9 | 1.3 |
| Comparative | 0.4 | 0.6 | 0.9 | 0.1 | 1.3 | 0.1 | 0.6 | −0.2 |
| Example 1 | | | | | | | | |

Next, comparisons of the sensory evaluation scores between levels (Examples 1, 2, and Comparative Example 1 with different WPI contents) were performed according to the Tukey-Kramer's HSD test.

Table 6 shows comparisons of the sensory evaluation scores between the levels (the numerical values in the table show p values by the Tukey-Kramer's HSD test). The case of p<0.1 was considered to have a significant trend, and the case of p<0.05 was considered to have a significant difference with a critical rate of 5%, and the case of p<0.01 was considered to have a significant difference with a critical rate of 1%.

TABLE 6

| | | | | | | | Degree of | | Feeling of |
|---|---|---|---|---|---|---|---|---|---|
| | | | Sourness | | Degree | Degree of | satisfactory | Clear | remaining |
| | | | in latter | Preference | of rich | throat | drink | feeling of | in the |
| Level 1 | Level 2 | Sourness | stage | of sourness | taste | flow | feeling | aftertaste | mouth |
| Comparative | Example 1 | 0.182 | 0.077 | 0.415 | <.0001 | <.0001 | <.0001 | <.0001 | <.0001 |
| Example 1 | | | | | | | | | |
| Comparative | Example 2 | 0.414 | 0.349 | 0.508 | <.0001 | <.0001 | <.0001 | 0.017 | 0.007 |
| Example 1 | | | | | | | | | |
| Example 1 | Example 2 | 0.866 | 0.696 | 0.986 | 0.292 | <.0001 | 0.001 | 0.023 | 0.054 |

In all the comparisons between levels, there was no significant difference in the sourness, the sourness in latter stage, and the preference of sourness, and it was found that a favorable sourness was maintained at an equal degree in all the liquid fermented milks.

It was found that a higher WPI content leads to a stronger feeling of remaining in the mouth with a significant difference or a significant trend, and thus, leads to a longer-lasting afterglow of a yogurt flavor. It was also found that a higher WPI content leads to higher degrees of rich taste and satisfactory drink feeling. The results demonstrated that both the liquid fermented milks of Examples 1 and 2 provide a feeling of long-lasting flavor (afterglow) and strong degrees of rich taste and satisfactory drink feeling while keeping a sourness that is favorable for yogurt.

It was suggested by the above results and the shear rate dependence in viscosity shown in FIG. 1 that the sourness was less or hardly affected by the viscosity.

### (Analysis of Correlation Between Physical Property Measurement Results and Sensory Evaluation Results of Samples)

The correlations between the physical property measurement results and the sensory evaluation results of the samples were analyzed according to Pearson's correlation analysis using a statistical software. The results are shown in Table 7. Table 7 shows correlations between physical property measurement results and sensory evaluation results of the samples.

TABLE 7

| | | | | | | | | Upper | Lower | |
|---|---|---|---|---|---|---|---|---|---|---|
| | Upper | Middle | Lower | | | | Thickness | part | part | Shear |
| | part | part | part | δ | Final | Maximum | attenuation | transit | transit | stress |
| | velocity | velocity | velocity | thickness | thickness | thickness | slope | time | time | [N/m2] |
| Sourness | 1.00 | 0.91 | 0.38 | −0.91 | −0.92 | −0.94 | 0.95 | −1.00 | −0.46 | −0.90 |
| Sourness in | 0.65 | 0.18 | −0.53 | −0.18 | −0.22 | −0.25 | 0.30 | −0.58 | 0.46 | −0.17 |
| latter stage | | | | | | | | | | |
| Preference of | 0.95 | 0.68 | 0.00 | −0.67 | −0.70 | −0.73 | 0.76 | −0.92 | −0.08 | −0.67 |
| sourness | | | | | | | | | | |
| Degree of | −1.00 | −0.89 | −0.35 | 0.89 | 0.91 | 0.92 | −0.94 | 1.00 | 0.42 | 0.89 |
| rich taste | | | | | | | | | | |
| Throat flow | 0.96 | 0.97 | 0.55 | −0.97 | −0.98 | −0.99 | 0.99 | −0.98 | −0.62 | −0.97 |
| Degree of | −0.99 | −0.94 | −0.46 | 0.94 | 0.95 | 0.96 | −0.97 | 1.00 | 0.53 | 0.93 |
| satisfactory | | | | | | | | | | |
| drink feeling | | | | | | | | | | |
| Clear feeling | 0.95 | 0.98 | 0.58 | −0.98 | −0.99 | −0.99 | 1.00 | −0.97 | −0.65 | −0.98 |
| of aftertaste | | | | | | | | | | |
| Feeling of | −0.92 | −0.99 | −0.66 | 0.99 | 1.00 | 1.00 | −1.00 | 0.95 | 0.72 | 0.99 |
| remaining in | | | | | | | | | | |
| the mouth | | | | | | | | | | |

The sourness in latter stage had no correlation to any of the physical properties.

The feeling of remaining in the mouth had a significant positive correlation (r=1.00 for each) to the final thickness and to the maximum thickness. This demonstrated that a drinking yogurt having a strong feeling of remaining in the mouth, and a long-lasting afterglow, can be provided by increasing the final thickness or the maximum thickness.

There was a significant negative correlation (r=−1.00) between the degree of rich taste and the upper part velocity. This demonstrated that a drinking yogurt having an increased degree of rich taste can be provided by decreasing the upper part velocity.

The degree of satisfactory drink feeling had a strong positive correlation (r=0.93) to the shear stress. This demonstrated that a drinking yogurt having an increased degree of satisfactory drink feeling can be provided by increasing the shear stress.

The present invention is not limited to the embodiment described above. For example, the liquid fermented milk may be one obtained from a fermented milk base with various materials blended in addition to WPI. The lactic acid bacteria for fermentation may be other than those mentioned above. The material of the resin sheet forming the inclined surface of the measurement device may be a material other than PVA. Besides, the present invention can be appropriately modified within the scope that is obvious to a person skilled in the art.

1. A liquid fermented milk that has,
in a dynamic property measurement using a measurement device in which a sample of a liquid fermented milk is supplied from a supply unit disposed on an inclined surface onto the inclined surface, the sample supplied from the supply unit toward the inclined surface is detected with a supply sensor, the sample flowing down or sliding down through a predetermined point on the inclined surface is detected with an arrival sensor, a timing of a detection of the sample with each of the supply sensor and the arrival sensor is recorded with a timing recording unit, an image of the sample flowing down or sliding down on the inclined surface is taken from above the inclined surface to obtain a front image, an image of the sample flowing down or sliding down on the inclined surface is taken from a side of the inclined surface to obtain a lateral image, and a state parameter that represents a state of the sample flowing down or sliding down on the inclined surface is calculated using at least one of an output of the timing recording unit, the front image, and the lateral image, whereby a state of swallowing of the sample is simulatively reproduced and a movement and a shape of the sample are measured,
an upper part velocity of the sample flowing down or sliding down on the inclined surface of 0.2 m/s or more and 0.55 m/s or less,
a maximum thickness of the sample flowing down or sliding down on the inclined surface of 1.4 mm or more and 4 mm or less,
a final thickness of the sample flowing down or sliding down on the inclined surface of 0.20 mm or more and 0.7 mm or less, and
a shear stress of the sample flowing down or sliding down on the inclined surface of 0.0075 N/m² or more and 0.04 N/m² or less.

2. The liquid fermented milk according to claim 1, wherein the upper part velocity is 0.2 m/s or more and 0.50 m/s or less,
the maximum thickness is 1.7 mm or more and 4 mm or less,
the final thickness is 0.25 mm or more and 0.7 mm or less, and
the shear stress is 0.0080 N/m² or more and 0.03 N/m² or less.

3. The liquid fermented milk according to claim 2, wherein the upper part velocity is 0.3 m/s or more and 0.45 m/s or less,
the maximum thickness is 1.8 mm or more and 3 mm or less,
the final thickness is 0.29 mm or more and 0.6 mm or less, and
the shear stress is 0.0080 N/m² or more and 0.02 N/m² or less.

4. The liquid fermented milk according to claim 1, wherein the liquid fermented milk has a whey protein isolate (WPI) content of 0.6% or more.

5. The liquid fermented milk according to claim 4, wherein the WPI content is more than 0.6%.

6. The liquid fermented milk according to claim 5, wherein the WPI content is 0.7% or more.

7. The liquid fermented milk according to claim 6, wherein the WPI content is 1% or more.

8. The liquid fermented milk according to claim 1, wherein the liquid fermented milk does not contain at least one of a thickener and a stabilizer.

9. The liquid fermented milk according to claim 1, wherein the liquid fermented milk is produced by fermentation with at least one of Lactobacillus delbrueckii subsp. bulgaricus and Streptococcus thermophilus.
